(19) United States
(12) Patent Application Publication
(10) Pub. No.: US 2017/0218482 A1
(43) Pub. Date: Aug. 3, 2017

(54) RHODIUM ALLOYS

(71) Applicant: JOHNSON MATTHEY PUBLIC LIMITED COMPANY, London (GB)

(72) Inventors: Duncan Roy COUPLAND, Hertfordshire (GB); Robert Brinley MCGRATH, Hertfordshire (GB)

(21) Appl. No.: 15/500,730

(22) PCT Filed: Jul. 31, 2015
(86) PCT No.: PCT/GB2015/052237

§ 371 Date: Jan. 31, 2017

(30) Foreign Application Priority Data
Aug. 1, 2014 (GB) 1413723.6

(51) Int. Cl. C22C 5/04; H01T 13/39

(52) U.S. Cl. CPC C22C 5/04; H01T 13/39

(57) ABSTRACT

Disclosed is a rhodium alloy including: rhodium; one or more elements selected from the group consisting of iridium, platinum, palladium and ruthenium; and one or more elements selected from the group consisting of yttrium, zirconium and samarium. The alloy includes a greater quantity of rhodium as compared to any other individual element of the alloy. Also disclosed is an electrode, as well as a spark plug, including the claimed rhodium alloy.

### FIELD OF THE INVENTION

The present invention relates to rhodium alloys and to the use of the alloys, in particular, as spark ignition electrodes.

### BACKGROUND

US2007/194681 (to Denso Corporation) describes a spark plug for an internal combustion engine wherein at least one of the centre or ground electrodes comprises rhodium and an additive 0.3% to 2.5% by weight of one or more selected from earth rare elements, IVA elements, and VA elements, as listed in the periodic table of elements. US2007/194681 does not describe alloys comprising a second platinum group metal (PGM).

JP2001118660 (to NGK Spark Plug Co. Ltd.) describes a rhodium alloy comprising one or more of Re, Ir, W, Mo and Os within 3 to 38% mass. JP2001118660 does not describe alloys comprising one or more elements selected from the group consisting of yttrium, zirconium and samarium.

GB2060773A (to Champion Spark Plug Company) describes a spark igniter having inserts made of iridium, rhodium, ruthenium, osmium, alloys and ductile alloys of the named metals and, for service where the igniter is not heated to temperatures higher than about 1000° F. (537.8° C.), tungsten and its alloys and ductile alloys. GB2060773A does not exemplify the preparation of any alloys or their use as spark igniters.

J. R. Handley (Platinum Metals Review, 1989, 33, (2), 64-72 and 1990, 34, (4), 192-204) describes binary, ternary and complex rhodium alloys. Neither journal article describes the alloys of the present invention nor the use of rhodium alloys as spark ignition electrodes.

### SUMMARY OF THE INVENTION

The present inventors have developed rhodium alloys which have enhanced resistances to wear, such as those arising from exposure to sparks and oxidation. In addition, the alloys are also easy to manufacture.

In one aspect, therefore, the present invention provides a rhodium alloy comprising:
a) rhodium;
b) one or more elements selected from the group consisting of iridium, platinum, palladium and ruthenium; and
c) one or more elements selected from the group consisting of yttrium, zirconium and samarium;
   wherein the alloy comprises a greater quantity of rhodium as compared to any other individual element of the alloy.

In another aspect, the invention also provides a spark ignition electrode comprising a rhodium alloy as defined herein is provided.

In yet another aspect, a spark plug comprising a spark ignition electrode as defined herein is provided.

In another aspect, the invention provides the use of the rhodium alloys as defined herein in an electrode or spark plug.

### DETAILED DESCRIPTION

As described above, the present invention provides a rhodium alloy comprising:
a) rhodium;
b) one or more elements selected from the group consisting of iridium, platinum, palladium and ruthenium; and
c) one or more elements selected from the group consisting of yttrium, zirconium and samarium;
   wherein the alloy comprises a greater quantity of rhodium as compared to any other individual element of the alloy.

It will be understood that whilst the amounts of each element are given assuming that the base alloy is pure rhodium, in practical terms, the rhodium and the alloying elements may contain impurities at levels which would be normally expected for such metals.

Rhodium is a platinum group metal (PGM) which exhibits high melting and boiling points, as well as excellent oxidation and corrosion resistances. Rhodium also displays a low vapour pressure and high thermal conductivity which, when allied with the above properties, suit its potential for use as a spark ignition electrode. However, rhodium metal itself cannot be adequately exploited as a spark ignition electrode due to its relatively poor mechanical properties and relatively low density. The present inventors have found that the properties of rhodium which make it a poor spark ignition electrode can be improved by selective alloying. In this respect, the rhodium alloy of the present invention comprises rhodium as the main element in the alloy. Rhodium therefore is present in the alloy in the greatest quantity (as expressed as a percentage by weight (wt %)) as compared to any other individual element of the alloy (also expressed as a percentage by weight (wt %)). Any other element of the alloy is individually a minor element as compared to rhodium.

While each element or a combination of elements in the alloy may be expressed as a range, the total wt % of the rhodium alloy adds up to 100 wt %.

The rhodium alloy of the present invention may comprise about ≧30 wt % of rhodium, such as about ≧40 wt % of rhodium, such as about ≧50 wt % of rhodium. In one embodiment, the rhodium alloy may comprise about 30 to about 99 wt % of rhodium, such as about 30 to about 95 wt % of rhodium, for example about 40 to about 90 wt % of rhodium. In one preferred embodiment, the rhodium alloy comprises about 50 to about 99 wt % of rhodium, such as about 55 to about 95 wt %, for example about 70 to about 90 wt %.

The rhodium is alloyed with at least one of iridium, platinum, palladium or ruthenium. In this respect, up to about 49.99 wt % (e.g. about 0.01 to about 49.99 wt %) each of one or more elements selected from the group consisting of iridium, platinum and palladium may be present. Iridium, platinum and palladium have excellent solid solubilities with rhodium and, as such, are suitable as alloying elements in preparing rhodium alloys. In one embodiment, the rhodium alloy may comprise up to about 49.99 wt % of iridium, such as 0 to about 40 wt %, for instance about 0.01 to about 25 wt %, for example about 0.1 to about 20 wt %. In another embodiment, the rhodium alloy may comprise up to about 49.99 wt % of platinum, such as 0 to about 40 wt %, for instance about 0.01 to about 25 wt %, for example about 0.1 to about 20 wt %. In another embodiment, the rhodium alloy may comprise up to about 49.99 wt % of palladium, such as 0 to about 49 wt %, for instance about 0.01 to about 25 wt %, for example about 0.1 to about 20 wt %.

When present in the rhodium alloy, ruthenium may be present in up to about 35 wt %. In this regard, it is generally desirable to limit the quantity of ruthenium to about ≦35 wt % as the solid solubility of ruthenium in rhodium is good within this range whilst retaining a single phase solid solution. Ruthenium is suitable as an alloying element as its corrosion resistance is similar to that of iridium. The presence of ruthenium (and/or iridium), therefore, improves the corrosion resistance of the rhodium alloy as compared to rhodium metal alone. Ruthenium also exhibits high melting/boiling points, high atomic weight and high thermal conductivity, all characteristics which are favourable for resistance to spark erosion. The rhodium alloy may comprise no ruthenium i.e. 0 wt % ruthenium. Alternatively, the rhodium alloy may comprise about 0.01 to about 35 wt % ruthenium, such as about 0.1 to about 34 wt %, for instance about 1 to about 32 wt %, for example about 5 to about 31 wt %.

The rhodium alloy may also comprise up to about 5 wt % (such as about 0 to about 5 wt %) each of any one of more elements selected from the group consisting of niobium, tantalum, titanium, chromium, molybdenum, cobalt, rhenium, vanadium, aluminium, hafnium and tungsten, preferably niobium, tantalum, titanium, chromium, molybdenum, cobalt, rhenium and tungsten, more preferably chromium and/or tungsten. Without wishing to be bound by theory, it is believed that the inclusion of these elements may ductilise the alloys i.e. make the alloys more tolerant to deformation and ease of manufacture. The rhodium alloy may comprise ≧about 0.01 wt %, such as, ≧about 0.05 wt %, ≧about 0.1 wt %, ≧about 0.15 wt % or ≧about 0.2 wt % each of the elements selected from the group consisting of niobium, tantalum, titanium, chromium, molybdenum, cobalt, rhenium, vanadium, aluminium, hafnium and tungsten, preferably niobium, tantalum, titanium, chromium, molybdenum, cobalt, rhenium and tungsten. The rhodium alloy may comprise ≦about 4.5 wt %, such as ≦about 4.0 wt %, ≦about 3.5 wt %, ≦about 3.0 wt %, ≦about 2.5 wt %, ≦about 2.0 wt %, ≦about 1.5 wt %, ≦about 1.0 wt %, ≦about 0.5 wt %, ≦about 0.4 wt % or ≦about 0.3 wt % each of the elements selected from the group consisting of niobium, tantalum, titanium, chromium, molybdenum, cobalt, rhenium, vanadium, aluminium, hafnium and tungsten, preferably niobium, tantalum, titanium, chromium, molybdenum, cobalt, rhenium and tungsten. In one embodiment, about 0.01 to about 5 wt % each may be present, such as about 0.05 to about 2.5 wt %, for example, about 0.1 to about 1.0 wt %. When chromium is present, it may be present in 0 to about 1 wt %, such as about 0.2 wt %. When tungsten is present, it may be present in about 0.1 to about 0.5 wt %, such as about 0.1 to about 0.3 wt %.

The rhodium alloy comprises one or more elements selected from the group consisting of yttrium, zirconium and samarium, preferably zirconium. Without wishing to be bound by theory, it is believed that the inclusion of these elements may ductilise the alloys as described above. It is also believed that the elements (in particular zirconium) may hinder dislocation movement through grain boundaries (i.e. the boundaries between crystal lattices at different orientations) and hence limit or slow grain growth. Grain growth therefore appears to be reduced at temperature ensuring a fine grain structure is retained. The rhodium alloy may comprise about 0.01 to about 0.50 wt % each of any one or more elements selected from the group consisting of yttrium, zirconium and samarium. The rhodium alloy may comprise ≧about 0.015 wt %, ≧about 0.02 wt %, ≧about 0.025 wt % or ≧about 0.030 wt % each of any one or more elements selected from the group consisting of yttrium, zirconium and samarium. The rhodium alloy may comprise ≦about 0.45 wt %, ≦about 0.40 wt %, ≦about 0.35 wt %, ≦about 0.30 wt %, ≦about 0.25 wt %, ≦about 0.20 wt %, ≦about 0.15 wt %, ≦about 0.10 wt %, ≦about 0.05 wt % or ≦about 0.04 wt % each of any one or more elements selected from the group consisting of yttrium, zirconium and samarium.

In one embodiment, the rhodium alloy may comprise about 0.01 to about 0.50 wt % of zirconium. The rhodium alloy may comprise ≧about 0.015 wt %, ≧about 0.02 wt %, ≧about 0.025 wt % or ≧about 0.030 wt % of zirconium. The rhodium alloy may comprise ≦about 0.45 wt %, ≦about 0.40 wt %, ≦about 0.35 wt %, ≦about 0.30 wt %, ≦about 0.25 wt %, ≦about 0.20 wt %, ≦about 0.15 wt %, ≦about 0.10 wt %, ≦about 0.05 wt % or ≦about 0.04 wt % of zirconium.

In another embodiment, the rhodium alloy may comprise about 0.01 to about 0.50 wt % of yttrium. The rhodium alloy may comprise ≧about 0.015 wt %, ≧about 0.02 wt %, ≧about 0.025 wt % or ≧about 0.030 wt % of yttrium. The rhodium alloy may comprise ≦about 0.45 wt %, ≦about 0.40 wt %, ≦about 0.35 wt %, ≦about 0.30 wt %, ≦about 0.25 wt %, ≦about 0.20 wt %, ≦about 0.15 wt %, ≦about 0.10 wt %, ≦about 0.05 wt % or ≦about 0.04 wt % of yttrium.

In yet another embodiment, the rhodium alloy may comprise about 0.01 to about 0.50 wt % of samarium. The rhodium alloy may comprise ≧about 0.015 wt %, ≧about 0.02 wt %, ≧about 0.025 wt % or ≧about 0.030 wt % of samarium. The rhodium alloy may comprise ≦about 0.45 wt %, ≦about 0.40 wt %, ≦about 0.35 wt %, ≦about 0.30 wt %, ≦about 0.25 wt %, ≦about 0.20 wt %, ≦about 0.15 wt %, ≦about 0.10 wt %, ≦about 0.05 wt % or ≦about 0.04 wt % of samarium.

It will be appreciated that elemental yttrium, zirconium and/or samarium is utilised and not e.g. oxides of yttrium, zirconium and/or samarium. In this respect, the oxides are typically added to an alloy which has already been prepared and is mechanically mixed with it. This is in contrast to elemental yttrium, zirconium and/or samarium which are dissolved in the continuous solution formed during the alloy's synthesis. Yttrium, zirconium and/or samarium, therefore, are alloying constituents.

In one preferred embodiment, the rhodium alloy may comprise about 0.02 to about 0.20 wt % each of any one or more elements selected from the group consisting of yttrium, zirconium and samarium. In another preferred embodiment, the rhodium alloy may comprise about ≧0.03 wt % each of any one or more elements selected from the group consisting of yttrium, zirconium and samarium, such as about ≧0.04 wt %. In yet another preferred embodiment, the rhodium alloy may comprise about ≦0.175 wt % each of any one or more elements selected from the group consisting of yttrium, zirconium and samarium, such as about ≦0.15 wt %, for example, about ≦0.125 wt %.

In one embodiment, the rhodium alloy comprises:
a) about 75 to about 95 wt % of rhodium;
b) about 15 to about 25 wt % each of any one or more elements selected from the group consisting of iridium, platinum and palladium;
c) 0 wt % of ruthenium;
d) about 0.01 to about 5 wt % each of any one or more elements selected from the group consisting of niobium, tantalum, titanium, chromium, molybdenum, cobalt, rhenium, vanadium, aluminium, hafnium and tungsten; and
e) about 0.01 to about 0.50 wt % each of any one or more elements selected from the group consisting of yttrium, zirconium and samarium;
   wherein the total wt % of the rhodium alloy adds up to 100 wt %.

In one preferred embodiment, the rhodium alloy may comprise about ≧76 wt % of rhodium, for example about ≧77 wt %, such as about ≧78 wt % or about ≧79 wt %. In another preferred embodiment, the rhodium alloy may comprise about ≦94 wt % of rhodium, for example about ≦93 wt %, such as about ≦92 wt % or about ≦91 wt %. In one preferred embodiment, the rhodium alloy comprises about 80 wt % of rhodium. In another preferred embodiment, the rhodium alloy comprises about 90 wt % of rhodium.

In one preferred embodiment, the rhodium alloy comprises about 15 to about 25 wt % of iridium. In another preferred embodiment, the rhodium alloy comprises about 15 to about 25 wt % of platinum. In yet another embodiment, the rhodium alloy comprises about 15 to about 25 wt % of palladium.

In one preferred embodiment, the rhodium alloy may comprise about ≧16 wt % each of any one or more elements selected from the group consisting of iridium, platinum and palladium, for example about ≧17 wt %, such as about ≧18 wt % or about ≧19 wt %. In another preferred embodiment, the rhodium alloy may comprise about ≦24 wt % each of any one or more elements selected from the group consisting of iridium, platinum and palladium, for example about ≦23 wt %, such as about ≦22 wt % or about ≦21 wt %.

In one preferred embodiment, the rhodium alloy may comprise about 0.01 to about 5 wt % of niobium. In another preferred embodiment, the rhodium alloy may comprise about 0.01 to about 5 wt % of tantalum. In yet another preferred embodiment, the rhodium alloy may comprise about 0.01 to about 5 wt % of titanium. In another preferred embodiment, the rhodium alloy may comprise about 0.01 to about 5 wt % of chromium. In yet another preferred embodiment, the rhodium alloy may comprise about 0.01 to about 5 wt % of molybdenum. In another preferred embodiment, the rhodium alloy may comprise about 0.01 to about 5 wt % of cobalt. In yet another preferred embodiment, the rhodium alloy may comprise about 0.01 to about 5 wt % of rhenium. In another preferred embodiment, the rhodium alloy may comprise about 0.01 to about 5 wt % of vanadium. In yet another preferred embodiment, the rhodium alloy may comprise about 0.01 to about 5 wt % of aluminium. In another preferred embodiment, the rhodium alloy may comprise about 0.01 to about 5 wt % of hafnium. In yet another preferred embodiment, the rhodium alloy may comprise about 0.01 to about 5 wt % of tungsten. When the rhodium alloy comprises tungsten, the tungsten may be present in about 0.05 to about 2.5 wt %, such as about 0.06 to about 1.5 wt %, for example, about 0.07 to about 1 wt % e.g. about 0.1 to about 0.3 wt %. When the rhodium alloy comprises chromium, the chromium may be present in about 0.05 to about 2.5 wt %, such as about 0.06 to about 1.5 wt %, for example, about 0.07 to about 1 wt % e.g. about 0.1 to about 0.3 wt %.

In one preferred embodiment, the rhodium alloy comprises about 0.01 to about 5 wt % each of any one or more elements selected from the group consisting of niobium, tantalum, titanium, chromium, molybdenum, cobalt, rhenium, vanadium, aluminium, hafnium and tungsten, preferably niobium, tantalum, titanium, chromium, molybdenum, cobalt, rhenium and tungsten, more preferably chromium and/or tungsten. The rhodium alloy may comprise about ≧0.05 wt % each of any one or more elements selected from the group consisting of niobium, tantalum, titanium, chromium, molybdenum, cobalt, rhenium, vanadium, aluminium, hafnium and tungsten, for example about ≧0.10 wt %, such as about ≧0.15 wt % or about ≧0.20 wt %. The rhodium alloy may comprise about ≦2.50 wt % each of any one or more elements selected from the group consisting of niobium, tantalum, titanium, chromium, molybdenum, cobalt, rhenium, vanadium, aluminium, hafnium and tungsten, for example about ≦2.00 wt %, such as about ≦1.50 wt % or about ≦1.00 wt %.

In one preferred embodiment, the rhodium alloy may comprise about 0.01 to about 0.50 wt % of zirconium. In another preferred embodiment, the rhodium alloy may comprise about 0.01 to about 0.50 wt % of yttrium. In yet another preferred embodiment, the rhodium alloy may comprise about 0.01 to about 0.50 wt % of samarium.

In one preferred embodiment, the rhodium alloy may comprise about 0.02 to about 0.20 wt % each of any one or more elements selected from the group consisting of yttrium, zirconium and samarium. In another preferred embodiment, the rhodium alloy may comprise about ≧0.03 wt % each of any one or more elements selected from the group consisting of yttrium, zirconium and samarium, such as about ≧0.04 wt %. In yet another preferred embodiment, the rhodium alloy may comprise about ≦0.175 wt % each of any one or more elements selected from the group consisting of yttrium, zirconium and samarium, such as about ≦0.15 wt %, for example, about ≦0.125 wt %.

In another embodiment, the rhodium alloy comprises:
a) about 50 to about 95 wt % of rhodium;
b) up to about 45 wt % each of any one or more elements selected from the group consisting of iridium, platinum and palladium;
c) about 1 to about 35 wt % of ruthenium;
d) up to about 5 wt % each of any one or more elements selected from the group consisting of niobium, tantalum, titanium, chromium, molybdenum, cobalt, rhenium, vanadium, aluminium, hafnium and tungsten; and
e) about 0.01 to about 0.50 wt % each of any one or more elements selected from the group consisting of yttrium, zirconium and samarium;
   wherein the total wt % of the rhodium alloy adds up to 100 wt %.

In one preferred embodiment, the rhodium alloy may comprise about ≧55 wt % of rhodium, for example about ≧60 wt %, such as about ≧65 wt % or about ≧70 wt %. In another preferred embodiment, the rhodium alloy may comprise about ≦94 wt % of rhodium, for example about ≦93 wt %, such as about ≦92 wt %, about ≦91 wt % or about ≦90 wt %.

In one preferred embodiment, the rhodium alloy comprises up to about 45 wt % of iridium. In another preferred embodiment, the rhodium alloy comprises up to about 45 wt % of platinum. In yet another preferred embodiment, the rhodium alloy comprises up to about 45 wt % of palladium.

In one preferred embodiment, the rhodium alloy may comprise about 0 to about 45 wt % each of any one or more elements selected from the group consisting of iridium, platinum and palladium, for example about ≧5 to about 15 wt %, such as about 7.5 to about 12.5 wt %. In one particularly preferred embodiment, the rhodium alloy comprises 0 wt % of iridium. In another particularly preferred embodiment, the rhodium alloy comprises about 9.86 wt % of iridium.

In one preferred embodiment, the rhodium alloy may comprise about 5 to about 30 wt % ruthenium, such as about 6 to about 25 wt %, for example about 7.5 to about 22.5 wt %. In one particularly preferred embodiment, the rhodium alloy comprises about 9.86 wt % of ruthenium. In another particularly preferred embodiment, the rhodium alloy comprises about 20 wt % ruthenium.

In one preferred embodiment, the rhodium alloy may comprise about 0.01 to about 5 wt % of niobium. In another preferred embodiment, the rhodium alloy may comprise about 0.01 to about 5 wt % of tantalum. In yet another preferred embodiment, the rhodium alloy may comprise about 0.01 to about 5 wt % of titanium. In another preferred embodiment, the rhodium alloy may comprise about 0.01 to about 5 wt % of chromium. In yet another preferred embodiment, the rhodium alloy may comprise about 0.01 to about 5 wt % of molybdenum. In another preferred embodiment, the rhodium alloy may comprise about 0.01 to about 5 wt % of cobalt. In yet another preferred embodiment, the rhodium alloy may comprise about 0.01 to about 5 wt % of rhenium. In another preferred embodiment, the rhodium alloy may comprise about 0.01 to about 5 wt % of vanadium. In yet another preferred embodiment, the rhodium alloy may comprise about 0.01 to about 5 wt % of aluminium. In another preferred embodiment, the rhodium alloy may comprise about 0.01 to about 5 wt % of hafnium. In yet another preferred embodiment, the rhodium alloy may comprise about 0.01 to about 5 wt % of tungsten. When the rhodium alloy comprises tungsten, the tungsten may be present in about 0.05 to about 2.5 wt %, such as about 0.06 to about 1.5 wt %, for example, about 0.07 to about 1 wt % e.g. about 0.1 to about 0.3 wt %. When the rhodium alloy comprises chromium, the chromium may be present in about 0.05 to about 2.5 wt %, such as about 0.06 to about 1.5 wt %, for example, about 0.07 to about 1 wt % e.g. about 0.1 to about 0.3 wt %.

In one preferred embodiment, the rhodium alloy may comprise about 0.01 to about 5 wt % each of any one or more elements selected from the group consisting of niobium, tantalum, titanium, chromium, molybdenum, cobalt, rhenium, vanadium, aluminium, hafnium and tungsten, preferably niobium, tantalum, titanium, chromium, molybdenum, cobalt, rhenium and tungsten, more preferably chromium and/or tungsten. The rhodium alloy may comprise about ≧0.05 wt % each of any one or more elements selected from the group consisting of niobium, tantalum, titanium, chromium, molybdenum, cobalt, rhenium, vanadium, aluminium, hafnium and tungsten, for example about ≧0.10 wt %, such as about ≧0.15 wt % or about ≧0.20 wt %. The rhodium alloy may comprise about ≦2.50 wt % each of any one or more elements selected from the group consisting of niobium, tantalum, titanium, chromium, molybdenum, cobalt, rhenium, vanadium, aluminium, hafnium and tungsten, for example about ≦2.00 wt %, such as about ≦1.50 wt % or about ≦1.00 wt %.

In one preferred embodiment, the rhodium alloy may comprise about 0.01 to about 0.50 wt % of zirconium. In another preferred embodiment, the rhodium alloy may comprise about 0.01 to about 0.50 wt % of yttrium. In yet another preferred embodiment, the rhodium alloy may comprise about 0.01 to about 0.50 wt % of samarium.

In another preferred embodiment, the rhodium alloy may comprise about 0.02 to about 0.40 wt % each of any one or more elements selected from the group consisting of yttrium, zirconium and samarium. In another preferred embodiment, the rhodium alloy may comprise about ≧0.03 wt % each of any one or more elements selected from the group consisting of yttrium, zirconium and samarium, such as about ≧0.04 wt %. In yet another preferred embodiment, the rhodium alloy may comprise about ≦0.35 wt % each of any one or more elements selected from the group consisting of yttrium, zirconium and samarium, such as about ≦0.30 wt %.

Rhodium alloys according to the present invention may be selected from the group consisting of:

| | Rh | Ir | Ru | Cr | W | Zr |
|---|---|---|---|---|---|---|
| Alloy | (wt %) | (wt %) | (wt %) | (wt %) | (wt %) | (wt %) |
| 1 | 80 | 19.86 | 0 | 0 | 0.1 | 0.04 |
| 2 | 90 | 0 | 9.86 | 0 | 0.1 | 0.04 |
| 3 | 80 | 19.46 | 0 | 0.20 | 0.30 | 0.04 |
| 4 | 70 | 9.86 | 20 | 0 | 0.10 | 0.04 |

The enhanced physical and mechanical properties of the rhodium alloys of the present invention make them suitable for use in high temperature or load bearing applications. As the average temperature of a spark plug typically cycles between 500-900° C. and the alloys of the present invention demonstrate good resistance to weight loss at high temperatures, the present alloys may be used in ignition applications, e.g. as components in spark-plugs. The alloys may also be suitable for use as electrodes and some biomedical applications in view of their radio-opacity. The foregoing examples merely serve to illustrate the many potential uses of the present alloys and, as such, are not intended to be limiting in any way.

The rhodium alloys may be manufactured by known methods and fabricated into any suitable form. Improvements in elongation to failure, or ductility, make the alloys particularly suitable for drawing into wires; however, the alloys may also be used to prepare tubes, sheets, grains, powders or other common forms. The alloys may also be used in spray coating applications.

Embodiments and/or optional features of the invention have been described above. Any aspect of the invention may be combined with any other aspect of the invention, unless the context demands otherwise. Any of the embodiments or optional features of any aspect may be combined, singly or in combination, with any aspect of the invention, unless the context demands otherwise.

The invention will now be described by way of the following non-limiting Examples and with reference to the accompanying figures in which:

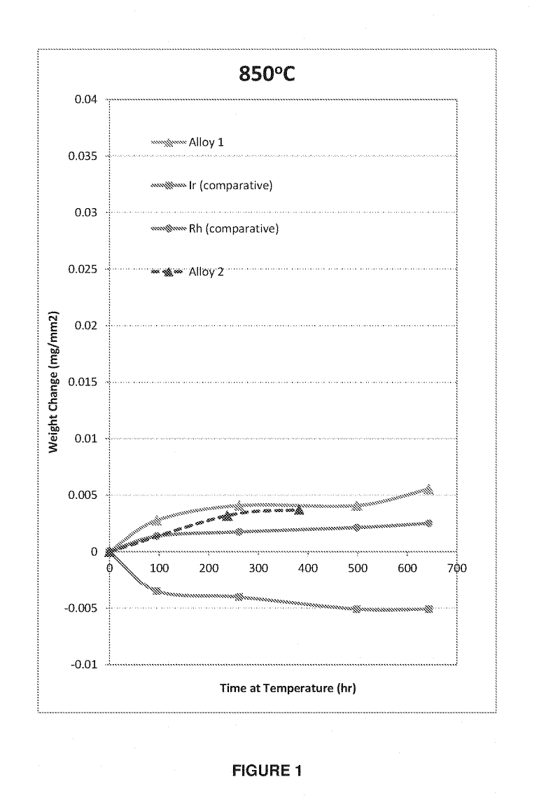

FIG. 1 illustrates the oxidation performance of rhodium alloys of the present invention at 850° C.

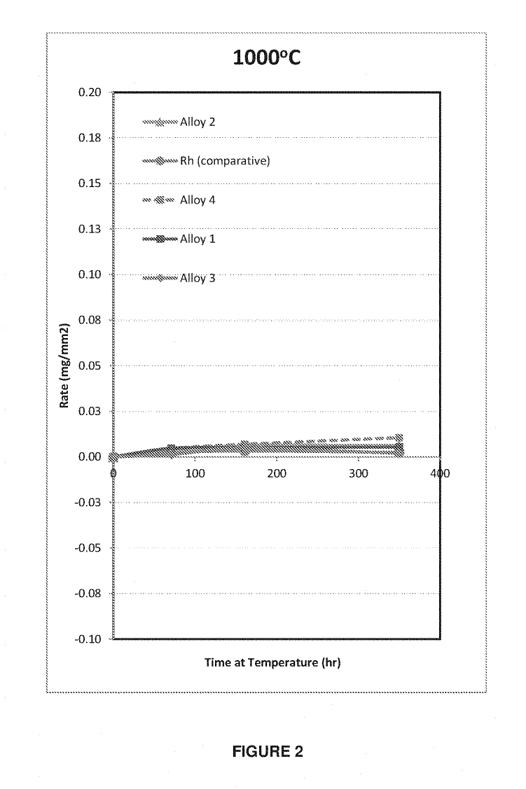

FIG. 2 illustrates the oxidation performance of rhodium alloys of the present invention at 1000° C.

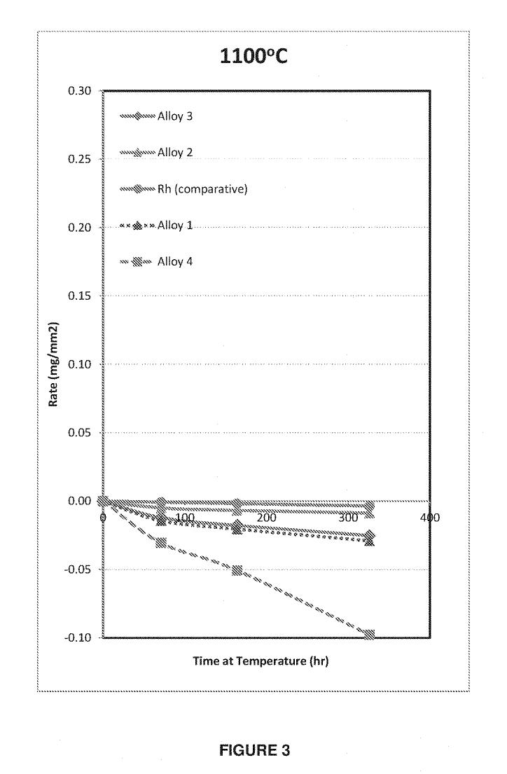

FIG. 3 illustrates the oxidation performance of rhodium alloys of the present invention at 1100° C.

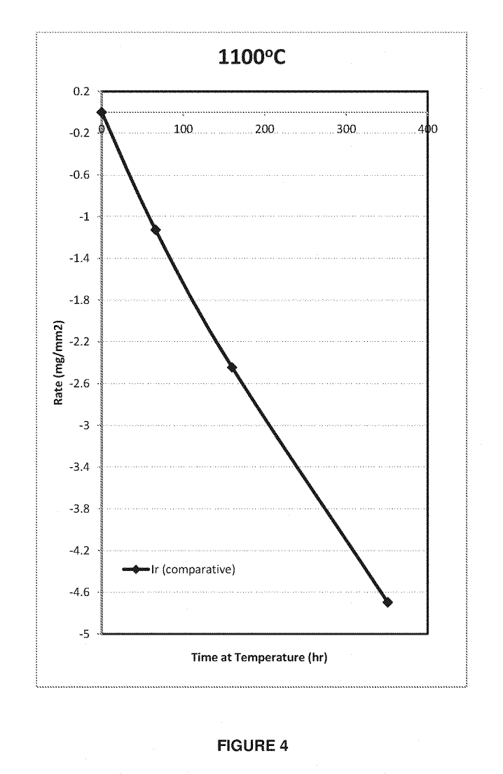

FIG. 4 illustrates the oxidation performance of iridium at 1100° C.

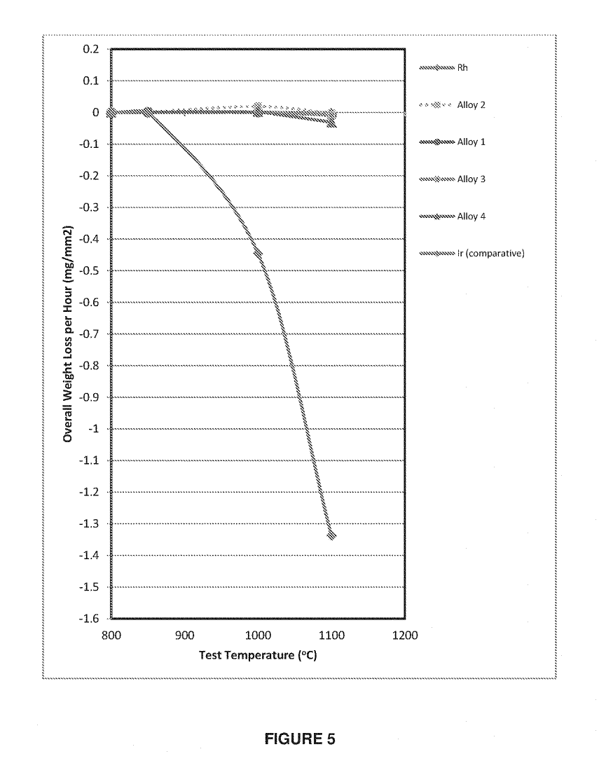

FIG. 5 illustrates the overall weight loss per hour of the rhodium alloys of the present invention at temperatures between 800° C. and 1100° C.

### EXAMPLES

### Example 1

### Alloy Preparation

The rhodium alloys detailed in Table 1 below are prepared by argon arc melting. All values are given in weight percent (wt %) based on the total weight of the alloy.

TABLE 1

| | Rh | Ir | Ru | Cr | W | Zr |
|---|---|---|---|---|---|---|
| Alloy | (wt %) | (wt %) | (wt %) | (wt %) | (wt %) | (wt %) |
| 1 | 80 | 19.86 | 0 | 0 | 0.1 | 0.04 |
| 2 | 90 | 0 | 9.86 | 0 | 0.1 | 0.04 |
| 3 | 80 | 19.46 | 0 | 0.20 | 0.30 | 0.04 |
| 4 | 70 | 9.86 | 20 | 0 | 0.10 | 0.04 |

Each alloy is subsequently processed to produce wire having a 2 mm diameter.

### Example 2

### Oxidation Testing

The oxidation performance of the alloys is assessed as followed:
1. Wire at 2 mm diameter is cut into straight lengths of approx. 120 mm.
2. The wire samples are weighed to 4 decimal places on an enclosed set of scales and diameter measured at 5 points along each length. The average diameter is noted.
3. Wire samples from several different alloys are placed in a notched alumina based ceramic furnace tray.
   The positional order is randomised with the slot number for each sample being noted.
   Two samples are tested from at least some of the batches.
   Both measures are intended to check for any effect due to positional variation within the test furnace.
4. A laboratory heat treatment furnace (in this case of work zone 150×150×200 mm) is set to the required test temperature.
5. Once stabilised, the furnace tray is placed into the centre of the furnace; date and time are noted.
6. After a suitable interval the furnace tray is removed from the furnace and allowed to cool naturally.
7. Each wire sample is weight checked and the weight noted.
8. The furnace tray is returned to the heat treatment furnace maintaining the same orientation.
9. Sample weights are checked at least 3 times over the duration of the test: typical duration is 350-400 hrs.; date and time are noted.
10. On completion the final diameter is measured, calculated and noted as above.
11. Times and measurements are transferred to spread sheet and the oxidative weight loss curves calculated using weight change and weight change per unit surface area.

The results of the oxidation performance of the rhodium alloys of the present invention at temperature of 850° C., 1000° C. and 1100° C. are shown in FIG. 1-3. FIG. 5 illustrates the overall weight loss per hour of the rhodium alloys of the present invention at temperatures between 800° C. and 1100° C.

Metal loss through vaporisation occurs for iridium and this is clearly shown in FIGS. 4 and 5 for the Ir graph which has the steepest negative gradient.

The rhodium alloys of the present invention exhibit comparable or improved properties in comparison to rhodium metal. The rhodium alloys also demonstrate a resistance to weight loss at higher temperatures, unlike iridium metal which exhibits a weight loss of over an order of magnitude greater than the present alloys.

### Example 3

### Electrode Studies

The rhodium alloys of the present invention, an iridium standard and a rhodium standard are cut into electrode wire having 1 mm diameter. The wires are fixed into a four station test cell together with matching 3 mm diameter Ir earth electrodes and the gap between them adjusted and set with a vernier calliper. The test electrodes are set at negative polarity and the earth electrode as positive to concentrate erosion on the appropriate electrodes.

Testing commences with a 10 kV electric pulse driven by an automotive ignition coil being applied to each pair of electrodes at 200 Hz. This initiates a continuous series of rapid spark discharges between the electrodes as generated in a typical automotive engine. The test cell is visually checked at intervals to confirm functionality and after approximately 250 hr. the discharge is stopped and the electrode gap re-measured. A counter initiated at test commencement is used to measure elapsed time from which the number of spark discharges can be calculated.

The electrodes are reset in the test cell and discharge re-initiated. After a further approximately 250 hr. (approx. 500 hrs discharge time in total) the test is stopped and the same procedure of gap measurement and electrode inspection completed.

### Test Duration

The test duration and approximate number of sparks were calculated. Therefore, for a 20 day test:
20 days×24 hrs/day=480 hrs
480 hrs×3600 seconds/hr=1,728,000 seconds
1,728,000 seconds×200 sparks/second=345,600,000 sparks (per test point)

Measurements of Gaps

| | Test gap - negative electrode | | | |
|---|---|---|---|---|
| | Startpoint | Midpoint | Endpoint | Gap Growth |
| | Gap (mm) | Gap (mm) | Gap (mm) | (mm) |
| 100% Ir | 8.2 | 8.6 | 8.9 | 0.7 |
| (comparative) | | | | |
| 100% Rh | 8.1 | 8.2 | 8.4 | 0.3 |
| (comparative) | | | | |
| Alloy 1 | 8.2 | 8.3 | 8.5 | 0.3 |
| Alloy 3 | 8.1 | 8.2 | 8.3 | 0.2 |
| Alloy 4 | 8.0 | 8.1 | 8.2 | 0.2 |

The 100% Ir electrode exhibits the worst (greatest) erosion, the gap measurement changing by 0.7 mm+/−0.1 mm over the test duration.

The 100% Rh and Alloy 1, 3 and 4 electrodes exhibit less erosion that the 100% Ir electrode. The Alloy 1 electrode exhibits comparable erosion to the 100% Rh electrode, the gap measurement changing by 0.3 mm+/−0.1 mm over the test duration.

Alloys 3 and 4 exhibit the least erosion as the gap measurement changed by 0.2 mm+/−0.1 mm for each alloy over the test duration. Alloys 3 and 4 therefore are more resistant to erosion and demonstrate greater resistance than both 100% rhodium and 100% iridium electrodes.

1-9. (canceled)

10. A rhodium alloy comprising:
a) rhodium;
b) one or more elements selected from the group consisting of iridium, platinum, palladium and ruthenium; and
c) about 0.01 to about 0.5 wt % each of any one or more elements selected from the group consisting of yttrium, zirconium and samarium;
wherein the alloy comprises a greater quantity of rhodium as compared to any other individual element of the alloy.

11. A rhodium alloy according to claim 10, wherein the alloy comprises:
a) about 50 wt % or more of rhodium;
b) up to about 49.99 wt % each of any one or more elements selected from the group consisting of iridium, platinum and palladium;
c) up to about 35 wt % of ruthenium;
d) up to about 5 wt % each of any one or more elements selected from the group consisting of niobium, tantalum, titanium, chromium, molybdenum, cobalt, rhenium, vanadium, aluminium, hafnium and tungsten; and
e) about 0.01 to about 0.5 wt % each of any one or more elements selected from the group consisting of yttrium, zirconium and samarium;
wherein the rhodium alloy comprises at least one of iridium, platinum, palladium or ruthenium; and
wherein the total wt % of the rhodium alloy adds up to 100 wt %.

12. A rhodium alloy according to claim 11, wherein the alloy comprises:
a) about 75 to about 95 wt % of rhodium;
b) about 15 to about 25 wt % each of any one or more elements selected from the group consisting of iridium, platinum and palladium;
c) 0 wt % of ruthenium;
d) about 0.01 to about 5 wt % each of any one or more elements selected from the group consisting of niobium, tantalum, titanium, chromium, molybdenum, cobalt, rhenium, vanadium, aluminium, hafnium and tungsten; and
e) about 0.01 to about 0.50 wt % each of any one or more elements selected from the group consisting of yttrium, zirconium and samarium;
wherein the total wt % of the rhodium alloy adds up to 100 wt %.

13. A rhodium alloy according to claim 11, wherein the alloy comprises:
a) about 50 to about 95 wt % of rhodium;
b) up to about 45 wt % each of any one or more elements selected from the group consisting of iridium, platinum and palladium;
c) about 1 to about 35 wt % of ruthenium;
d) up to about 5 wt % each of any one or more elements selected from the group consisting of niobium, tantalum, titanium, chromium, molybdenum, cobalt, rhenium, vanadium, aluminium, hafnium and tungsten; and
e) about 0.01 to about 0.50 wt % each of any one or more elements selected from the group consisting of yttrium, zirconium and samarium;
wherein the total wt % of the rhodium alloy adds up to 100 wt %.

14. A rhodium alloy according to claim 11, wherein the alloy is selected from the group consisting of:

| | Rh | Ir | Ru | Cr | W | Zr |
|---|---|---|---|---|---|---|
| Alloy | (wt %) | (wt %) | (wt %) | (wt %) | (wt %) | (wt %) |
| 1 | 80 | 19.86 | 0 | 0 | 0.1 | 0.04 |
| 2 | 90 | 0 | 9.86 | 0 | 0.1 | 0.04 |
| 3 | 80 | 19.46 | 0 | 0.20 | 0.30 | 0.04 |
| 4 | 70 | 9.86 | 20 | 0 | 0.10 | 0.04 |

15. A spark ignition electrode comprising a rhodium alloy according to claim 10.

16. A spark plug comprising an electrode according to claim 15.

17. A spark ignition electrode comprising a rhodium alloy according to claim 11.

18. A spark ignition electrode comprising a rhodium alloy according to claim 12.

19. A spark ignition electrode comprising a rhodium alloy according to claim 13.

20. A spark ignition electrode comprising a rhodium alloy according to claim 14.
